(19) United States
(12) Patent Application Publication
(10) Pub. No.: US 2009/0056886 A1
(43) Pub. Date: Mar. 5, 2009

(54) Retractable flexible sound reduction system and method for doorways

(76) Inventor: William Bennett Shaw, Commack, NY (US)

Correspondence Address: BUCHANAN, INGERSOLL & ROONEY PC, POST OFFICE BOX 1404, ALEXANDRIA, VA, 22313-1404, US

(21) Appl. No.: 11/892,798

(22) Filed: Aug. 27, 2007

(51) Int. Cl. E06B 9/56; B23P 19/00; E04B 1/74; E06B 9/60; E06B 7/00; E06B 9/00

(52) U.S. Cl. 160/368.1; 160/311; 160/313; 160/84.02; 181/287; 29/700

(57) ABSTRACT

The disclosed system includes a flexible door covering dimensioned to cover all of a door opening, including at least a part of trim of the doorframe and at least part of a door threshold. The flexible door covering includes a sound reduction layer. The system further includes a flexible door covering retraction mechanism that can selectively let-out and retract the flexible door covering to selectively cover and uncover the door opening of the doorframe. The system includes a hold-down mechanism for holding the flexible door covering against the doorframe. The method includes mounting the sound reduction door covering and the flexible door covering retraction mechanism to a doorframe, such that the flexible door covering is let-out from the flexible door covering retraction mechanism until the flexible door completely covers the doorframe.

### FIELD OF THE DISCLOSURE

The present disclosure is directed to a sound reduction system and method for doorways.

### BRIEF DESCRIPTION OF BACKGROUND

A chronic problem facing people needing or desiring peace and quiet is that doors do not always offer sufficient sound reduction. Noise on the other side of the door creates distraction or keeps people awake. Whether circumstances involve infants needing a nap in a household with older children, college students needing to study (or take a nap), or mixed manufacturing/business settings where business is to be conducted, anywhere there is a somewhat noisy environment next to an area in which quiet or privacy is needed or desired, doors sometimes fail to provide sufficient sound reduction. Sound otherwise sufficiently reduced at the surrounding walls can sometimes easily penetrate lighter doors or doors that have gaps between the door and the doorway threshold.

In these circumstances, there are few practical solutions. One can replace the door with a heavier and/or better fitting door, but this is an expensive and difficult process and does not always provide the appropriate sound reduction. Further, matching the door style and color can present problems. Another solution includes fastening sound-deadening material on the door, but this can be intrusive in appearance and does not necessarily reduce the sound going though gaps around the door, such as at the threshold. Furthermore, for situations that are temporary in nature, such as infant years and year-to-year occupancy by sound sensitive people, replacing doors is impractical or prohibitive for a variety of reasons.

Further, in some settings there is a desire to provide artwork, logos of sports teams, people of notoriety (e.g., images of Einstein) or any imagery that reflects the interests and personalities of the occupant(s) of a room. Bed coverings, as well as pictures, posters and other wall coverings are the typical response, but people desire more creative ways to express themselves.

### SUMMARY OF THE DISCLOSURE

The present disclosure is directed to a sound reduction door covering system. The system includes a flexible door covering dimensioned to cover substantially all of a door opening of a doorframe, including covering at least a part of trim of the doorframe and at least part of a door threshold. The flexible door covering includes a sound reduction layer. The system further includes a flexible door covering retraction mechanism that can selectively let-out and retract the flexible door covering to selectively cover and uncover the door opening. The system includes a hold-down mechanism for holding the flexible door covering against the doorframe.

The disclosure further includes a method of reducing sound travel through a doorframe. The method includes mounting the sound reduction door covering and the flexible door covering retraction mechanism to a doorframe. The flexible door covering is let-out from the flexible door covering retraction mechanism until the flexible door completely covers the doorframe.

### BRIEF DESCRIPTION OF DRAWINGS

The present disclosure is explained by way of exemplary embodiments illustrated in the accompanying drawings to which the claimed invention is not limited.

FIG. 1 illustrates one embodiment of a sound reduction door covering according to the present disclosure.

FIG. 2 illustrates an aspect of the present disclosure related to the flexible door covering.

FIG. 3 illustrates another aspect of the present disclosure related to the flexible door covering retraction mechanism.

FIG. 4 illustrates another aspect of the present disclosure related to the flexible door covering retraction mechanism.

FIG. 5 illustrates another aspect of the present disclosure related to the flexible door covering retraction mechanism.

FIG. 6 illustrates another aspect of the present disclosure related to the flexible door covering hold-down mechanism.

FIG. 7 illustrates another aspect of the present disclosure related to the flexible door covering hold-down mechanism

### DETAILED DESCRIPTION OF DISCLOSED SYSTEM AND METHOD

The present invention will now be described by way of exemplary embodiments to which it is not limited, as illustrated in the accompanying drawings. As used herein, “door covering”, “door opening” and “doorframe” do not necessarily imply the presence of a door per se. The disclosed system would be useful even in applications where a door is not present but the opening in the wall was dimensioned to allow a person to wall through it comfortably. For instance, the door opening can be 80 inches high. Also, “threshold” does not require but can include a distinct board or length of other material, and alternatively can be of the surrounding floor material. It means the material in the region between the two sides of a door frame.

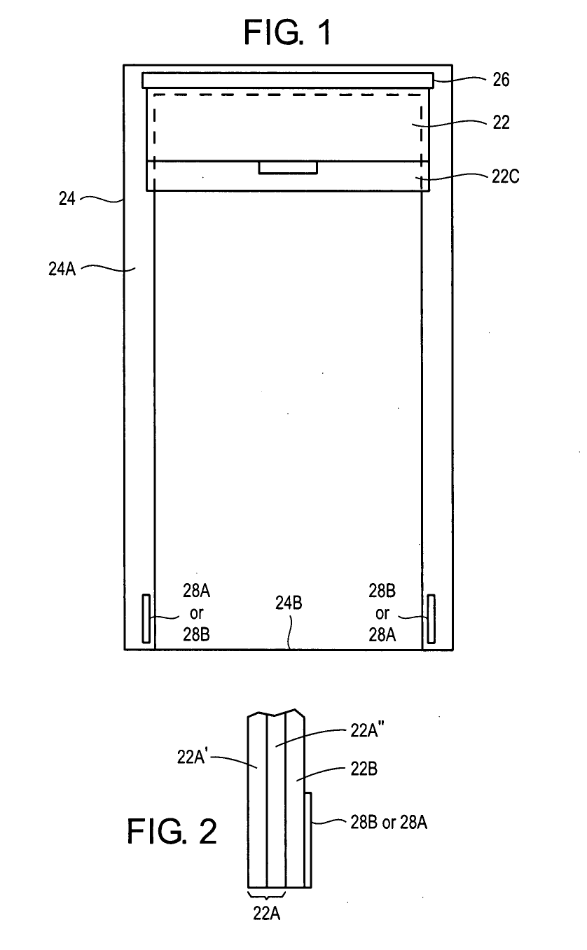

FIG. 1 illustrates a sound reduction door covering system (20). The system (20) includes three basic components. A first component is a flexible door covering (22). The flexible door covering (22) is dimensioned to cover all of a door opening and part of a doorframe (24) surrounding the door opening. The door frame (24) is defined in the present disclosure as the framing, surface coating (drywall or plaster) and trim (24A) that defines an opening at which a door might (or might not be) mounted. The trim (24A) can be simply a finished corner (e.g. drywall or plaster with corner bead), or profiled trim boards of nearly any dimension, cross section or shape that frames a door opening. The flexible door covering (22) extends over at least a part of trim (24A) of the doorframe (24) and at least part of a door threshold (24B). The flexible door covering (22) includes a sound reduction layer (22A), as explained in greater detail herein.

The second component is a flexible door covering retraction mechanism (26) that can selectively let-out and retract the flexible door covering (22) to selectively cover and uncover said door opening.

The third component is a hold-down mechanism (28) for holding the flexible door covering (22) against the doorframe (24) and door threshold (24B).

Each of these components will be further described below. It should be understood that the various aspects described below with respect to each individual component could be suitably mixed and matched with various aspects of other components, as desired, whether or not such combinations are specifically mentioned herein.

Flexible Door Covering

A reason the flexible door covering (22) is dimensioned to cover all of a door opening of a doorframe (24) is to reduce the ability of sound to pass through the door opening via any gaps that might otherwise exist if the door covering (22) was smaller than the doorframe (24) or through the door itself. However, this can be achieved in a number of ways. For instance, doorframes often have doorstops, which are relatively thin strips of material near the center of the thickness of doorframe (24) that act to stop the door from swinging through the doorframe (24). The flexible door covering (22) could extend only to the inner surface of the doorframe (24), and cover the doorstop. A more universal solution that requires less precise dimensioning of the width of the flexible door covering (22) is to have the flexible door covering (22) extend onto the door trim (24A). In this way, the flexible door covering (22) can be dimensioned within a range equal to the inner and outer dimensions of the door trim (24A) across the door opening. By way of non-limiting example, if the door trim (24A) consists of three and one half inch wide flat boards coplanar with the surrounding wall, a width of the flexible wall covering (22) can be roughly equal to the length between the inner edges of the door trim (24A), or as wide as the dimension between the outer edges of the door trim (24A), i.e., a range of up to seven inches, with the necessary accommodation of the flexible door covering retraction mechanism (26) and/or the flexible door cover hold-down mechanism (28). As mentioned above, the door trim (24A) can be simply a finished corner (e.g. drywall or plaster with corner bead), and the minimum width of the flexible covering (22) simply has to be to the door stops or the doorframe (24) from corner bead to corner bead, but the upper range is relatively unlimited, depending on such factors as esthetics and expense.

The flexible door covering (22) also extends over at least part of a door threshold (24B) for much the same reason, i.e., to reduce sound traveling under the door. The distal end (opposite to the flexible door covering retraction mechanism (26)) can include an additional length of material (22C) that will cover at least one inch of horizontal threshold (24B) of the doorframe (24). While there is no critical need for this additional length of material (22C) to be an inch, less than an inch might not completely cover the gap between door and floor, particularly of uneven or thresholds or door bottoms that are not level or square. Of course, the additional length of material (22C) can be more than an inch, but much more than six inches might cause people to trip when passing close to the door opening and would add little to its function of reducing sound passage through the doorframe (24).

The sound reduction layer (22A) can be of nearly any suitable material that reduces the passage of sound. There are known materials that act as sound-absorbing layers by absorbing the sound energy. Other materials act as sound-reflecting layers wherein the sound energy is simply reflected back in the general direction of its impingement or deflected away at an angle to the material surface. The composition and construction of these materials are known and, so long as they are flexible, are not important to the present invention. In fact, the sound reduction layer (22A) may include both sound-absorbing layer(s) and sound-reflecting layer(s) in any order relative to the sound source, with FIG. 2 showing a three layer construction of a decorative layer (22B) (not to scale) and both a sound absorbing and sound reflecting layers (22A′) and (22A″). The only criterion is that the material reduces the passage of sound therethrough to the perception of normal human hearing.

As explained in greater detail below, the flexible door covering (22), the flexible door covering retraction mechanism (26) and the hold-down mechanism (28), depending on design, will generally include decorations. These decorations can be directly applied to the flexible door covering (22) (and materials of the retraction mechanism (26) and hold-down mechanism (28)), but it is also possible for the flexible door covering (22) to include a decorative layer or film (22B) bearing decorations. The decorative layer (22B) could also be applied to suitable surfaces associated with the flexible door covering retraction mechanism (26) and/or flexible cover hold-down mechanism (28). The decorations of the decorative layer (22B) include child-oriented characters, for applications suitable for children and infants. For situations involving infants, it would be appropriate for the parents to have listening devices (so called “baby monitors”) in the room so that the sound reduction doorframe covering system (20) would not prevent the parent from hearing a child in distress. The baby monitor can be sold with, or separately from, or even integral with the sound reduction system (20) via a microphone placed in the room and a speaker and associated circuitry mounded to the retraction mechanism (26) as a non-limiting example.

The decorations on the decorative layer (22B) could include any one or more of entertainment stars, music bands, people of notoriety, sports figures, sports events, sports equipment, logos of sports teams and themed mosaics. Yet other possibilities include the decorative layer being blank or have blank space to permit custom decorations by an end user, addition of the name of the end user, etc. either at the end user site or through special order at a manufacturing or distribution center (e.g., via on-line up-loading of images for application to the flexible door covering (22) through an on-demand printing processes). The decorative layer (22B) or decorations applied directly to the sound reduction layer (22A), retraction mechanism (26) and hold-down mechanism (28)) can serve to personalize the sound reduction door covering system to the end user at least to some degree.

Flexible Door Covering Retraction Mechanism

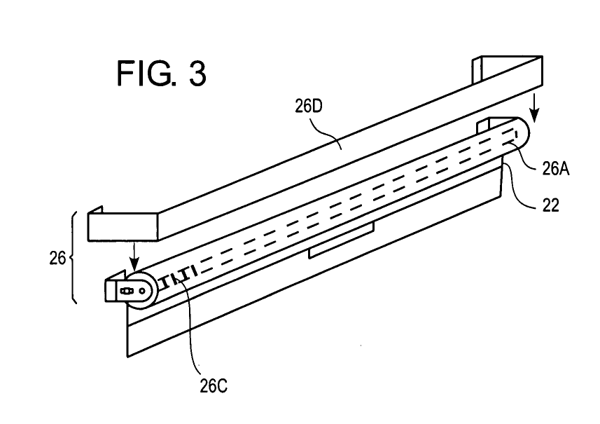

The flexible door covering retraction mechanism (26) can be of nearly any form that will permit the flexible door covering (22) to be effectively removed from the doorframe (24) to permit passage of people. In some exemplary applications, the flexible door covering retraction mechanism (26) could be a spring-loaded roll-up mechanism, such as shown in FIG. 3. Such roll-up mechanisms, by themselves, are known in the window dressing arts, and include a cylindrical tube or rod (26A) axially mounted via pins to brackets (26B) mounted to an adjacent wall. At least one to the pins has a cross section that is not round, and a spring mechanism (26C), either in the tube or on the bracket, can be biased against the non-circular feature of the pin or structures associated with the non-circular pins. A ratchet (not shown) in the spring mechanism (26C) permits the flexible door covering (22) to be let-out and locked in place to keep the flexible door covering (22) in its let-out position, until reactivated to permit the spring-loaded mechanism to retract the flexible door covering (22). The details of the spring-loaded roll-up mechanism are not particularly relevant, other than it is capable of letting out and retracting the flexible door covering (22).

In this regard, a handle dimensioned to receive a hand and at least a toe of an end-user can augment the spring-loaded roll-up mechanism. In this way, the end-user can pull the flexible door covering (22) down to a position that the end-user can comfortably bend to, then use his or her toe (with or without foot-ware) to push the handle down to the threshold (24B) such that the flexible door covering (22) completely covers the door opening and rely on the ratchet or the rod-and-hook combination described below to keep the flexible door covering (22) in its let-out position.

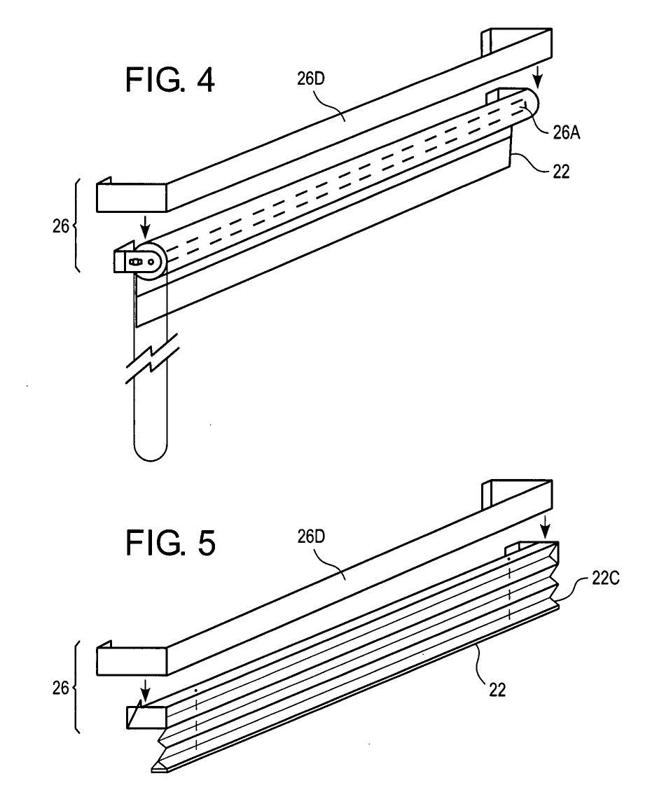

As alternatives, the flexible door covering retraction mechanism (26) can include a string operated roll-up mechanism as shown in FIG. 4, wherein the bracket (26B′) includes a pulley wheel (26C′) that is encircled by a loop of string that when pulled in one direction causes the flexible door covering (22) to be let-out, and when pulled in the other direction, retracts the covering back on a cylindrical or tube (26A′), as is known in the window dressing arts. This system can be augmented by, or the string simply replaced with, a motorized roll-up mechanism (nor shown).

While roll-up mechanisms have certain advantages such as the flexible door covering (22) being let-out in a flat, unwrinkled state, the retraction mechanism (26) can take the form of a pleat-forming system. Pleat-forming window coverings are known in the window dressing arts, and include a system of strings passing through apertures (hoops fastened to, or holes in, the flexible material) at intervals along the flexible material such that when the string is shortened or pulled up, the flexible material folds into pleats 22C as it is pulled up, as shown in FIG. 5.

Of course, to make the sound reduction door covering system (20) more universally useful to a variety of doorframes and door trim dimensions, the flexible door covering retraction mechanism (26) may include an adjustable bracket to position the flexible door covering (22) co-planar with door trims of various thicknesses. Ideally, the flexible door covering (22) would let the flexible material out at the surface level of the door trim. In fact, the bracket can include a biasing mechanism against the axial mounting pin of a roll-up cylinder, for instance, that will keep the position of the flexible door covering (22) as it is let out be immediately adjacent to the door trim (24A) as the diameter of the rolled up flexible door covering changes.

Additionally, the sound reduction door covering system (20) can be adjusted in length or width to fit a doorframe (24). This can be done at the manufacturing site, where standard door sizes can be kept in stock, but atypical door sizes can be accommodated by way of special order, for instance. Alternatively or additionally, the end user or installer can make the adjustments. For instance, at least part of said flexible door covering retraction mechanism (26), particularly the part that covers 26D the retracted flexible door covering (22), can be cut to length, either with the use of a saw or knife depending on the material. Alternatively or additionally, the cover part can have an adjustable length, such as a two part decorative cover wherein one part slides over the other. Similarly, the hold-down mechanism (28) can have an adjustable length. In embodiments further explained elsewhere herein, the hold-down mechanism (28) might be cut to a length that is sufficient to hold the door covering (22) to the door trim (24A). Parts of the hold-down mechanism (28) to be positioned on either side of the doorframe (24) may be selectively positioned on the door trim to accommodate the width of the flexible door covering (22) within ranges. Of course, the door covering (22) can be cut to length in both width and length, and may or may not need to have an edge treatment applied.

Flexible Door Covering Hold-Down Mechanism

The sound reduction door covering system (20) may include a hold-down mechanism (28) that uses magnets positioned when the flexible door covering is in its let-out state approximate to the bottom of the doorframe on, or as an integral part of, the flexible door covering (22) and/or the door frame (24). The magnets can be flexible or rigid magnets (28A) with matching rigid or flexible ferro metallic plates (28B), or in the form of small parts or even granules embedded in the flexible door covering (22). It does not particularly matter which is attached to the flexible door covering (22) or the doorframe (24), and they are generically referred to as magnetic pieces. As shown in FIG. 2, the magnetic pieces can be sewn onto the flexible door covering (22) on one hand and glued through adhesive tape or the like to the door trim of the doorframe (24). When the flexible door covering (22) is let out, magnetic pieces at its distal (lower) end will be attracted to magnetic pieces at the bottom of the doorframe (24). The part of the flexible door covering (22) that does not have magnetic pieces will be biased against the doorframe (24) by means of the flexible covering retraction mechanism (26) in certain embodiments, and in other embodiments the magnetic pieces can extend for a significant part of the flexible door covering (22) in its let-out position. Instead of magnetic pieces, the hold-down mechanism may include hook and loop fasteners commonly referred to by the trademark VELCRO.

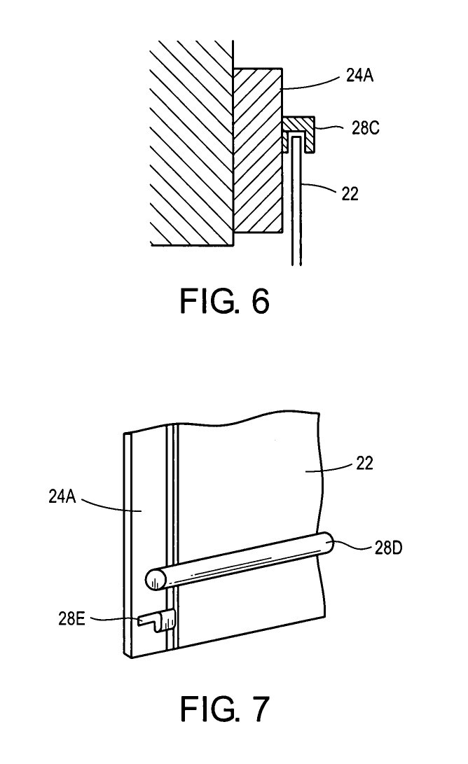

The hold-down mechanism (28) in other embodiments can include guides (28C) as shown in FIG. 6 on respective sides of the doorframe (24) extending from adjacent to the flexible door covering retraction mechanism (26) to the bottom of the doorframe (24). The guides can be U-shaped channels 28C with an adhesive backing on one leg. When the open part of the U-shaped channels are positioned facing each other on either side of the flexible door covering (22) in its let-out position, the adhesive-backed leg of the U-shaped channel can be adhered to the doorframe (24), or fastened via fasteners such as screws, so that the flexible door covering (22) is held adjacent to the doorframe (24). This is particularly appropriate for the spring-loaded or string drawn flexible door covering retraction mechanisms, described above.

The hold-down mechanism (28) may alternatively or additionally include a rod 28D traversing the flexible door covering (22) with rod extensions extending beyond the flexible door covering (22) on either side, and hooks 28E mounted to doorframe (24) near the bottom of the doorframe (24) that trap the rod extensions, as shown in FIG. 7. When used with a spring-loaded roll-up mechanism, a ratchet mechanism can be omitted, and the spring biasing is used to keep the flexible door covering (22) against the doorframe (24).

The hold-down mechanism (28) includes weights on said flexible door covering positioned approximate to the bottom of the doorframe (24). The weights may be granulated weights such as buckshot or sand. The hold-down mechanism (28) in certain embodiments can include the granulated weights in the additional length of material at the distal end of the flexible door covering (22).

Method of Reducing Sound Travel Through a Doorframe

A method of reducing sound travel through a doorframe (24) incorporates the sound reduction mechanism (20). It includes mounting the sound reduction door covering system (20) to a doorframe (24), and letting-out the flexible door covering (22) from the flexible door covering retraction mechanism (28) until the flexible door completely covers the door opening of the doorframe (24). The step of letting-out the flexible door covering (22) includes pulling on the handle with an end-user's hand for an initial distance, then completing the letting-out step by inserting the end-user's toe and pushing the handle down the handle to the threshold (24C) of the doorframe (24).

The present invention has been described by way of exemplary embodiments to which it is not limited. Variations and modifications will occur to those skilled in the art without departing from the scope of the present invention as defined in the appended claims.

What is claimed is:

1. A sound reduction door covering system, comprising:
a flexible door covering dimensioned to cover substantially all of a door opening of a doorframe including at least a part of trim of the doorframe and at least part of a door threshold, said flexible door covering including a sound reduction layer;
a flexible door covering retraction mechanism that can selectively let-out and retract said flexible door covering to selectively cover and uncover said door opening of the doorframe; and
a hold-down mechanism for holding said flexible door covering against said doorframe.

2. The sound reduction door covering according to claim 1, wherein said flexible door covering includes at its end opposite to the flexible door covering retraction mechanism an additional length of material that will cover at least one inch of horizontal threshold of said doorframe.

3. The sound reduction door covering according to claim 1, wherein said sound reduction layer includes a sound-absorbing layer.

4. The sound reduction door covering according to claim 1, wherein said sound reduction layer includes a sound-reflecting layer.

5. The sound reduction door covering according to claim 1, wherein said sound reduction layer includes both a sound-absorbing layer and a sound-reflecting layer.

6. The sound reduction door covering according to claim 1, wherein said flexible covering includes a decorative layer bearing decorations.

7. The sound reduction door covering according to claim 6, wherein said decorations of said decorative layer include child-oriented characters.

8. The sound reduction door covering according to claim 6, wherein said decorations of said decorative layer include at least one of entertainment stars, music bands, people of notoriety, sports figures, sports events, sports equipment, logos of sports teams and themed mosaics.

9. The sound reduction door covering according to claim 6, wherein said decorative layer has blank space to permit custom decorations by an end user.

10. The sound reduction door covering according to claim 1, wherein said flexible door covering retraction mechanism includes a spring-loaded roll-up mechanism.

11. The sound reduction door covering according to claim 1, wherein said flexible door covering retraction mechanism includes a spring-loaded roll-up mechanism and a handle dimensioned to receive a hand and at least a toe of an end-user.

12. The sound reduction door covering according to claim 1, wherein said flexible door covering retraction mechanism includes string operated roll-up mechanism.

13. The sound reduction door covering according to claim 1, wherein said flexible door covering retraction mechanism includes a motorized roll-up mechanism.

14. The sound reduction door covering according to claim 1, wherein said flexible door covering retraction mechanism includes a pleat forming system.

15. The sound reduction door covering according to claim 1, wherein said flexible door covering, at least part of said flexible door covering retraction mechanism and said hold-down mechanism are adjustable in at least one dimension selected from a group consisting of width and length.

16. The sound reduction door covering according to claim 1, wherein said flexible door covering retraction mechanism includes an decorative cover covering the flexible door covering when in a retracted position.

17. The sound reduction door covering according to claim 1, wherein said hold-down mechanism includes magnets positioned approximate to the bottom of said doorframe of at least one of said flexible door covering and door trim.

18. The sound reduction door covering according to claim 1, wherein said hold-down mechanism includes hook and loop fasteners.

19. The sound reduction door covering according to claim 1, wherein said hold-down mechanism includes guides on respective sides of a doorframe extending from adjacent to the flexible door covering retraction mechanism to a bottom of said door frame.

20. The sound reduction door covering according to claim 1, wherein said hold-down mechanism includes a rod traversing said flexible door covering with rod extensions extending beyond said flexible door covering on either side, and hooks mounted to door trim near the bottom of the doorframe that traps said rod extensions.

21. The sound reduction door covering according to claim 1, wherein said hold-down mechanism includes weights on said flexible door covering positioned approximate to the bottom of said doorframe.

22. The sound reduction door covering according to claim 1, wherein said hold-down mechanism includes granulated weights.

23. The sound reduction door covering according to claim 22, wherein said hold-down mechanism includes granulated weights in said additional length of material.

24. A method of reducing sound travel through a door frame, comprising:
mounting said sound reduction door covering according to claim 1 to a door frame;
letting-out said flexible door covering from said flexible door covering retraction mechanism until said flexible door completely covers substantially all of the door opening.

25. The method of claim 24, wherein said step of letting-out said flexible door covering includes pulling on a handle dimensioned to receive a hand and at least a toe of an end-user with an end-user's hand for an initial distance, then completing the letting-out step by inserting the end-user's toe and pushing the handle down the handle to the threshold of the door frame.
